(19) United States
(12) Patent Application Publication
(10) Pub. No.: US 2002/0095851 A1
(43) Pub. Date: Jul. 25, 2002

(54) Fishing lure elevator

(76) Inventor: Earl G. Petry, Askov, MN (US)

Correspondence Address: Angenehm Law Firm, Ltd., P.O. Box 48755, Coon Rapids, MN, 55448-0755, US

(21) Appl. No.: 09/764,240

(22) Filed: Jan. 19, 2001

(51) Int. Cl. A01K 69/00; A01K 71/00; A01K 73/00

(52) U.S. Cl. 43/4.5

(57) ABSTRACT

A device for urging a fishing lure to a greater depth in the water and altering the action of a fishing lure by causing the fishing lure to move upwardly and downwardly at intervals when trolled behind a moving boat to enhance the attractiveness of the fishing lure to the fish.

### BACKGROUND OF THE INVENTION

The invention relates to a fishing aid, and more particularly to a trolling plane for varying the depth of a trolled lure.

When fishing, it is necessary to bring the lure to the fish. This is relatively easy to do when fishing in shallow water or for species of fish that inhabit shallow water. The lure is merely attached to a line, which is pulled, or trolled, behind a boat. The depth of the lure can be varied by varying the length of the line towing the lure. That is, the more line the operator lets out, the deeper the lure will troll. When seeking deep water dwelling species of fish, the problem becomes getting a lure to sufficient depth where the fish are found, however, a point is reached where regardless of how much line is let out, the lure will troll no deeper.

To increase the depth that a fishing lure seeks or trolls at many devices have been tried. Conventional methods for causing a lure to troll deeper have included adding weights to the line to drag the lure deeper, adding planer elements to the line to draw the lure deeper. These planer elements are commonly called otter boards, trolling planes, or other regional names. Another conventional method of drawing a lure deeper is to use a separate line to pull a downrigger ahead of the lure so that the downrigger is set to the selected depth and the lure is attached to the downrigger.

While all of the aforementioned devices will allow deeper trolling of a fishing lure, none of them address the problem that fish do not normally swim in a straight line. Thus, a lure that is trolled in a straight line will appear “artificial” to a fish. Various methods of producing erratic movement of the lure have been tried including various lips or planes added to the lure to cause the lure to dart left or right; or up and down. While the added lips and planes do work, the degree of movement provided is limited and the movement tends to be patterned unlike the erratic movements of a bait fish. In some instances, the lips or planes have been built in to the lure which makes the lure more smooth and streamlined, but, this form has the same benefits and limits of the external lips or planes.

In some instances, attempts to provide erratic movement is done by operator action, that is the operator will alternately bring in and let out line to cause the lure to rise and fall becoming more similar to the movement of a bait fish. While the manual operation or jigging will cause the lure to move more erratically, the effectiveness of jigging lessens as the amount of line in the water increases until a point is reached where the jigging of the operator is virtually ineffective. Additionally, when a down rigger on a separate line is used to bring the lure deeper, the operator is prevented from jigging.

Various devices have been used in attempts to provide the desired erratic movement for fishing lures. Most are at best, or limited use in that they will work effectively only with lures or a certain size, or at certain depths.

### SUMMARY OF THE INVENTION

The invention as disclosed herein is a trolling device, and more particularly is an active trolling plane for imparting an erratic movement to the towed lure. The fishing lure elevator consists of a main body plane with a stabilizing keel and a leading canard type lip which is moved in relation to the main body to cause the fishing lure elevator to move alternately upwardly and downwardly to emulate the erratic darting movement of a bait fish.

The fishing lure elevator is placed between the fishing lure and the operator and may be attached directly to the fishing line or the fishing line may be affixed first to a downrigger. As the fishing lure elevator is drawn through the water the forward canard lip is mechanically powered between up positions and down positions to cause the trailing lure to move up and down in somewhat erratic movement.

### BRIEF DESCRIPTION OF THE DRAWINGS

FIG. 1 is a diagrammatic view showing the fishing lure elevator in use showing the relationship among the elements necessary to utilize the fishing lure elevator.

FIG. 2 is a side elevation view of the fishing lure elevator.

FIG. 3 is an overhead plan view of the fishing lure elevator.

FIG. 4 is a partial cut away view of the actuating mechanism taken along line 4-4 of FIG. 3.

### DESCRIPTION OF THE PREFERRED EMBODIMENT

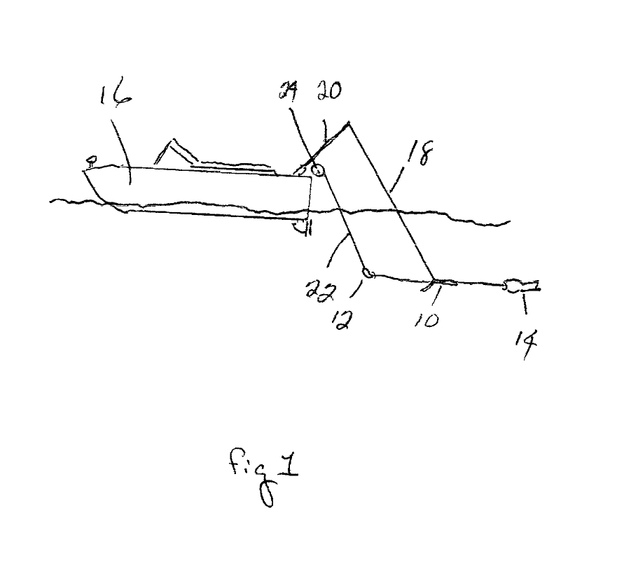

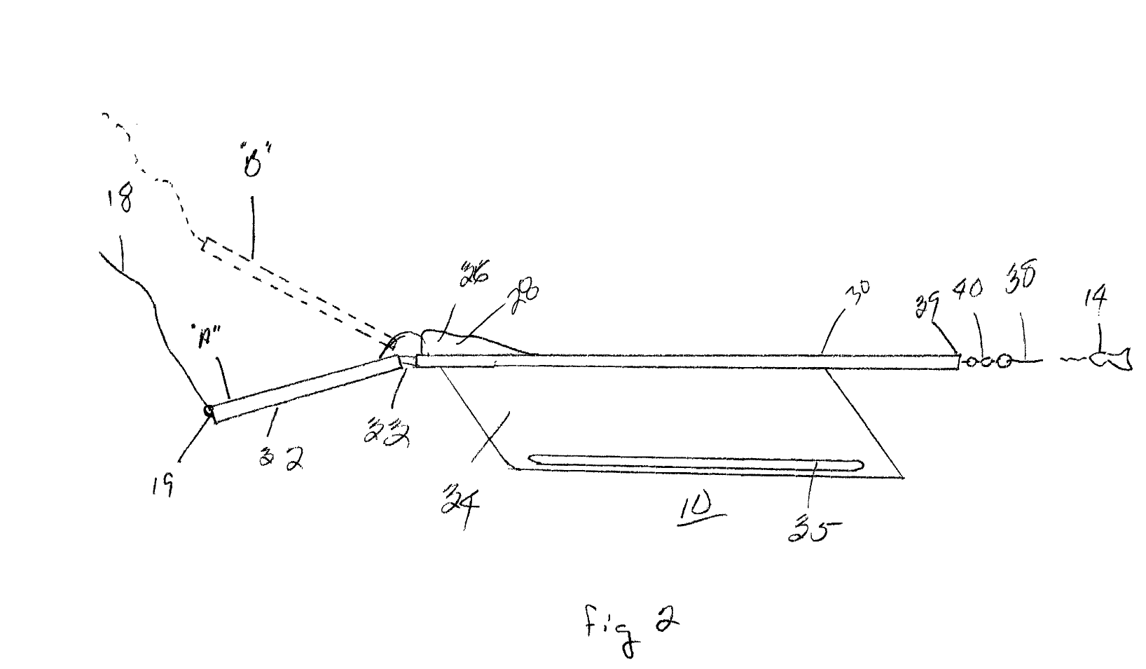

Looking first to FIG. 1, which shows the fishing lure elevator 10 being used with a separate downrigger 12 to impart movement to a fishing lure 14. The apparatus is towed by a boat 16. The fishing line 18 runs from a reel (not shown) on the fishing rod 20 through the water to the fishing lure elevator 10 and thence to the fishing lure 14. A separate downrigger line 22 is used to position the downrigger 12. The downrigger line 22 is stored on a downrigger reel 24 and may be let out a selected amount to place the downrigger 12 and thence the fishing lure 14 at a selected depth. The fishing line 18 is hitched to downrigger 12 using a conventional method of removable attachment such as clips or other removable attachment mechanism. There are many conventional methods of removable attachment that are well known in the art and readily available.

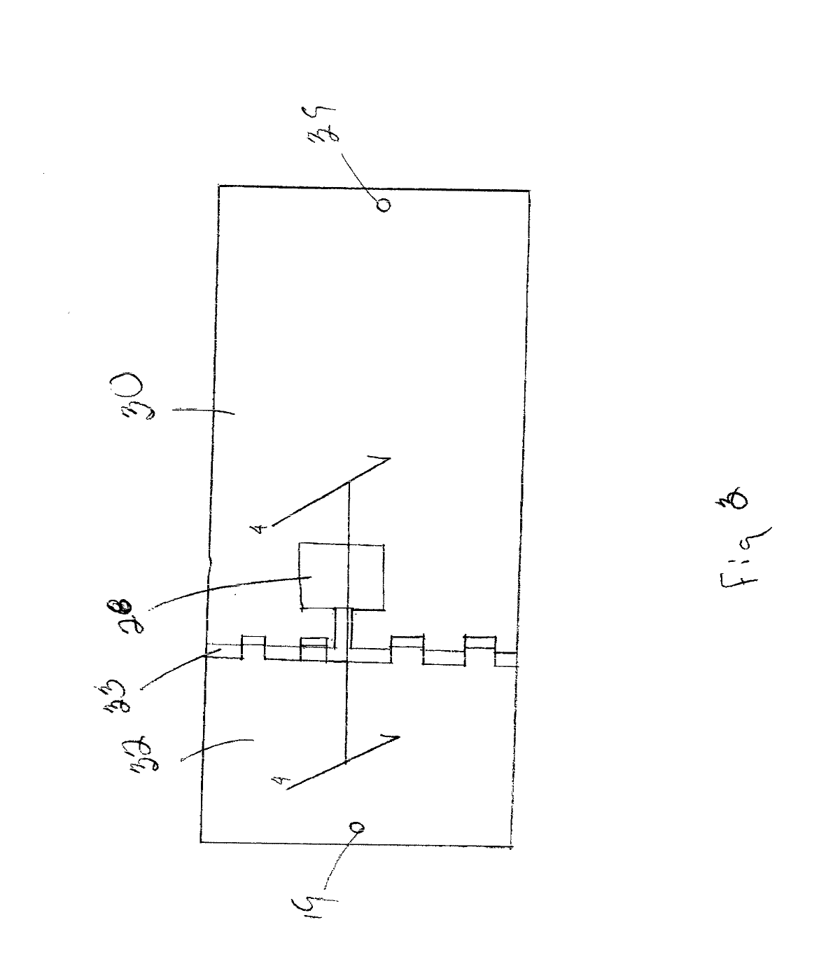

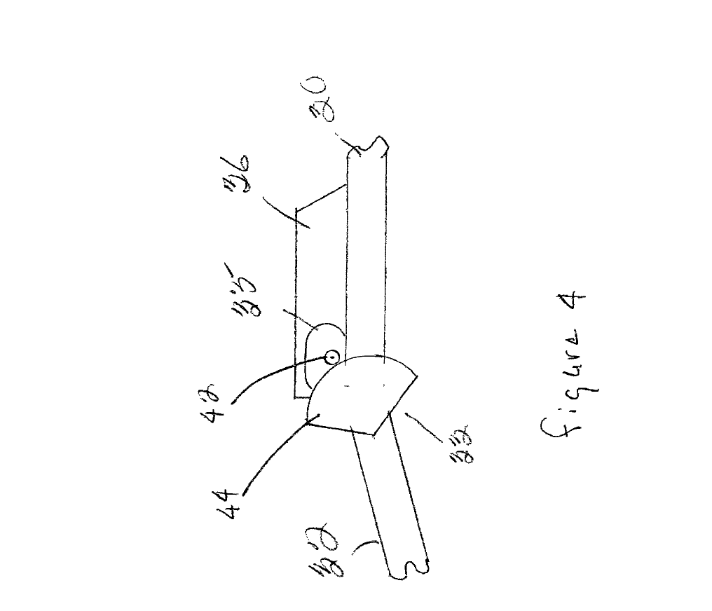

The fishing lure elevator 10 as shown in greater detail in FIG. 2, where the fishing lure elevator 10 is composed of the main body 30 and the forward or canard lip 32. The body 30 has a keel 34 extending downwardly from the body 30 to stabilize the fishing lure elevator 10. A motor housing 26 may be located atop the body 30 containing a motor 28 and the related mechanism for moving the canard lip 32 with respect to the body 30.

The canard lip 32 extends forward of the body 30 and is attached to the body 30 using a hinge mechanism 33. The hinge mechanism 33 may be any of a numerous hinge mechanisms, such as a flexible area between the body 30 and the canard lip 32 or a pin and knuckle hinge. The canard lip further includes a fishing line attachment 19 for attaching the fishing line 14.

The keel 34 is preferably located at right angles to the plane of the body 30 and has additional weights 36 along the located proximate the lower edge. The weights 36 ballast the fishing lure elevator 10 in the position, as shown in FIG. 2, for stability. A lure line 38 is attached to the rear portion of the body 30 using the lure line attachment 39 and the lure line 38 extends therefrom to the fishing lure 14. It is preferred that a swivel 40 is interposed between the lure line 38 and the body 30. While the swivel 40 is not necessary, it is advantageous to use a swivel 40 to prevent the fishing lure 14 from twisting the lure line 38, even when using a fishing lure 14 that does not rotate. When a rotating fishing lure 14 is used, the swivel 40 becomes necessary or the twisted lure line 38 will affect the action of the fishing lure 14. Without a swivel 40, there can be excessive twisting of the lure line 38 to a degree that the fishing lure elevator 10 may be destabilized.

The body 30 may be formed from a thin sheet of any suitable material, such as plastic, glass filled plastic, metal, or any other suitable material. The keel 34 is likewise formed from a thin sheet of any suitable material, such as plastic, glass filled plastic, metal, or any other suitable material. The selection of materials effects other facets of the fishing lure elevator 10, for example, should the fishing lure elevator 10 be fabricated from metal, then the keel 34 would be attached to the body 30 by welding or brazing and the weights 36 may be formed integral with the keel 34. However, when the fishing lure elevator 10 is formed from a plastic material, the keel 34 may be formed integral with the body 30, but, the weights 36 must be formed from a denser material, such as lead, and added to the keel 34.

The canard lip 32 may be formed from the same materials as described for forming the body 30 above. It is preferred that the canard lip 32, the body 30 and the keel 34 be constructed from the same material. The canard lip 32 is linked to the body 30 through the hinge mechanism 33. The hinge mechanism 33 allows the canard lip 32 to be moved among positions of approximately “A” and “B” as shown in FIG. 2. When the canard lip 32 is in the “down” position, as indicated by “A,”the fishing lure elevator 10 is urged downwardly in the water and will dive to the extent allowed by the length of the line between the fishing lure elevator 10 and the downrigger 12. Similarly, when the canard lip 32 is in the “up” position as indicated by “B” in FIG. 2, the fishing lure elevator 10 with be urged upwardly in the water to the extent allowed by the length of the line between the fishing lure elevator 10 and the downrigger 12.

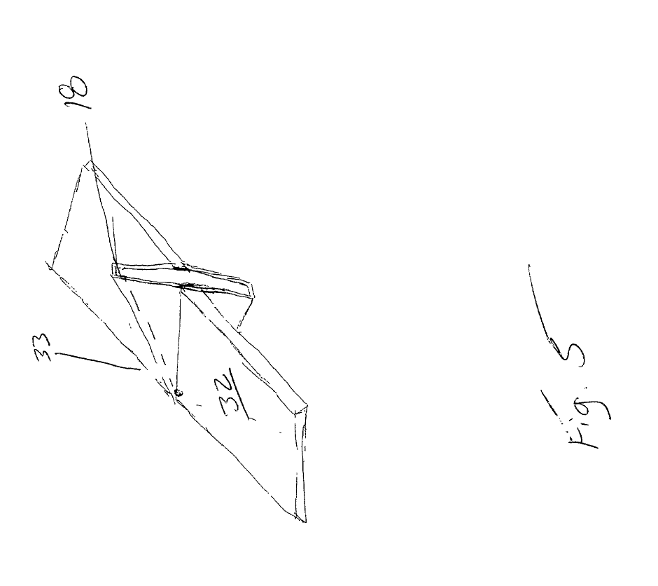

While there are many different methods of moving the canard lip 32 among the “up” and “down” positions, of necessity, all cannot be discussed. In one embodiment of the invention, as shown in FIG. 4, the motor 28 is a stepper motor and actuates the movement through a gear 42 and sector 44 arrangement. The gear 42 is affixed to the output shaft of the motor 28 and the sector 44 is formed on trailing edge of the canard lip 32 proximate the hinge mechanism 33 and is located to engage the gear 42. In its simplest construction, the a battery or other power source is located in the motor housing 26 to power the motor 28 along with a very simple control circuit that cycles the canard lip 32 between an “up” position” and a “down” position, allowing a pre-selected time to elapse before actuating the cycling. Timing circuits for this control are well known in the art and readily available and may be miniaturized quite easily.

Alternately, the power source and control circuit may be removed from the motor housing 26 and the motor 28 connected through waterproof wiring to a power supply and control circuit that remains on the boat 16. In this form, the power supply can be either a larger battery or the fishing lure elevator 10 can take power from the power supply of the boat 16. Moving the control circuitry and power source from the fishing lure elevator 10 to the boat 16 also allows a physically larger power supply and a more complex controller.

When using electrical controls, the movement of the canard lip 32 and therefore the fishing lure elevator 10 can be varied from the simple example previously disclosed or can be much more complicated by allowing the various parameters such as changing the angle of the canard lip 32 with respect to the body 30, allowing the canard lip 32 to assume multiple “up” and “down” positions; or altering the time the canard lip remains an “up” or “down” position before being moved to a “down” or “up” position.

In another alternate embodiment, the control circuitry is controlled by a microprocessor which allows the user to set the parameters. The user can set the “up” and “down” angle of the canard lip 32 to increase or decrease the distance the fishing lure 14 departs from a straight path. The user can also set the time the canard lip 32 remains in one position before moving to the alternate position, again effecting the path taken by the fishing lure 14. Alternately, the parameters can generated by the microprocessor and be random or at least pseudo-random. With all of the parameters randomized, the canard lip 32 would be placed in randomly determined “up” angle for a random length of time, the canard lip 32 would then be moved to a randomly selected “down” angle for another random length of time. These settings would impart an erratic movement to the fishing lure 14.

In the electrical embodiments of the fishing lure elevator 10 miniaturization of the controls would allow user setable controls to be integrated with the motor housing 26 so that the fishing lure elevator 10 would be setable without necessitating a separate control module.

In another electrical embodiment of the fishing lure elevator 10, (not shown) the motor 28, gear 42 and sector 44 are replaced with a solenoid and toggle linkage where the solenoid toggles the canard lip 32 between its “up” and “down” position while the linkage is arranged so that the canard lip 32 is held in either the “up” or “down” position by the linkage. In this embodiment, the canard lip 32 is either up or down and there can be no moderation of the angle of the canard lip 32 without changing linkage.

In any of the remotely controlled electrical embodiments of the fishing lure elevator 10 there may be a selectable third position for the canard lip 32 s(not shown). The third position is to place the canard lip 32 coplanar with the body 30 so that after a fish has been hooked, the canard lip 32 movement does not inhibit the recovery of the fish.

In another alternate embodiment, (not shown) the energy necessary to move the canard lip 32 with respect to the body is derived from the motion of the fishing lure elevator 10 through the water. A water wheel such as a pelton wheel can be located to extend below the body 30 and into the water flow to collect energy for storage in a spring. When the spring has stored sufficient energy, the energy is released to move the canard lip 32 to its alternate position. The actuation mechanism may be the gear 42 and sector 44 linkage described previously with regard to the electrical embodiments, or the toggle linkage similar to the toggle linkage as described previously.

FIG. 5 shows an alternate canard lip 32 is shown. In this embodiment a central opening 31 is shown where the fishing line may be attached near the hinge 33 and extend forward through the opening 31. The opening 31 is a vertical slot that allows the line to remain in a constant location relative to the device 10 as the canard lip 32 toggles up and down.

In its use, the operator must first prepare the fishing lure elevator 10 for use by attaching a fishing line 14 to the fishing line attachment 19 of the canard lip 32 and attaching a swivel 40 to the lure line attachment 39 and attaching the lure line 38 thereto. A fishing lure 14 must then be selected. The operator selects the fishing lure 14 based on the desired species of fish being sought the experience, and quite often the whim of the operator.

When the operator is using a fishing lure elevator 10 having integrated control with setable settings, the operator will then check and if deemed appropriate reset the settings may be changed, for example, may wish to have a longer time elapse between up and down cycles of the fishing lure elevator 10, if so, the operator changes the appropriate setting.

When the use of a downrigger 12 is desired, the operator must determine the distance behind the downrigger 12 that the fishing lure elevator 10 will be towed. The operator will then removably attach the fishing line 14 to the downrigger 12.

With or without a downrigger 12, the fishing lure elevator 10 with attached lure is then dropped over the stern of the boat 16 and the boat 16 powered allowing the fishing lure elevator 10 to sink below the surface of the water to a depth set by either the depth of the downrigger 12 or the length of fishing line 18 that is let out. At this point, the fishing lure 14 is ready to be fished.

When the fishing lure 14 is being fished, the fishing lure 14 is trolled through the water by the movement of the boat 16 and whatever movements inherent in the fishing lure 14 are manifest.

As the fishing lure elevator 10 and fishing lure 14 are trolled through the water, the canard 32 starts in either an up or down position which will be arbitrarily be the “down” position, as shown by “A” in FIG. 2, the fishing lure elevator 10 is drawn downwardly. After the appropriate lapse of time or distance, the motor 28 is energized to move the canard lip 32 into an “up” position as shown by position “B” in FIG. 2 thusly elevating the fishing lure elevator 10 in the water. Again, after the appropriate lapse of time or distance, the motor 28 is again energized to move the canard lip 32 back to the position as shown by “A” in FIG. 2, and the cycle repeats.

It is hoped that after a short period of time a fish will strike the fishing lure 14 and become impaled on its hooks. Upon this pleasant happening, additional tension is placed upon the fishing line 14 releasing its removable attachment to the downrigger 12 allowing the fishing line 14 to be retrieved with the attached fish until the fish is close enough to the boat 16 to be landed. When a remotely controlled electrical fishing lure elevator 10 is being used, the user preferably selects the retrieve position for the canard lip 32 to facilitate the recovery of the fish.

With the fish thusly landed, or, after the hooked fish escapes, the operator performs the steps necessary to ready the fishing lure elevator 10 for another troll, as described above. At the conclusion of the fishing expedition the fishing lure elevator 10 and the fishing lure 14 are recovered to the boat 16, and if necessary, powered down, and replace in its storage location.

Although the present invention has been described with reference to preferred embodiments, workers skilled in the art will recognize changes may be made in form and detail without departing from the spirit and scope of the invention.

What is claimed:

1. A device for controlling the depth of a towed fishing lure comprising
a. a planer body having a front end and a back end, and having a stabilizing weighted keel extending downwardly from the diving body,
b. a planer canard diving plane hingedly attached and extending forwardly from the body,
c. powered means for moving the canard diving plane with respect to the diving body and holding the depth plane in a plurality of positions with respect the diving body;
d. control means for controlling the movement of the canard diving plane to cycle the diving plane among the plurality of positions.

2.. The invention as described in claim 1 wherein the keel is planer and further the keel is plane perpendicular to the body.

3. The invention as described in claim 1 wherein the weighting of the weighted keel is adjustable.

4. The invention as described in claim 1 wherein the planer canard diving plane further comprises a toothed gear sector extending rearwardly therefrom and the powered means further comprises a motor with a gear meshing with the gear sector of the canard diving plane.

5. The invention as described in claim 4 wherein the motor is electrically powered.

6. The invention as described in claim 4 wherein the motor is powered by the motion of the fishing lure elevator.

7. The invention as described in claim 5 wherein the control means further comprises an electrical timing circuit for toggling the position of the canard lip between an up position and a down circuit.

8. The invention as described in claim 1 wherein the canard diving plane is movable between an up position and a down position through a toggle linkage.

9. The invention as described in claim 8 wherein the toggle linkage is electrically powered.

10. The invention as described in claim 8 wherein the toggle linkage is powered by the movement of the fishing lure elevator through the water.

11. The invention as described in claim 5 wherein the control means further comprises a microprocessor for controlling the movement of the canard diving plane.

12. The invention as described in claim 11 wherein the parameters for moving the canard diving plane are settable.

13. The invention as described in claim 11 the angle of the up setting and the down setting of the canard diving plane is settable.

14. The invention as described in claim 11 wherein the parameters for moving the canard diving plane are determined randomly by the microprocessor.

15. A process for taking fish from a body of water comprising the steps of
a. attaching a main fishing line from an onboard line receptacle to the fishing lure elevator;
b. connecting a fishing lure to a fishing lure elevator using a swivel and a selected length of fishing line;
c. removably attaching the main fishing line to a downrigger a selected distance from the fishing lure elevator;
d. placing the main fishing line, the downrigger, the fishing lure elevator, and the fishing lure in the water behind the boat while extending the main fishing line and the downrigger line out a selected distance;
e. activating and controlling the fishing lure elevator to toggle the canard lip among the “up” and “down” positions while trolling the lines, downrigger, fishing lure elevator and fishing lure through the water.

16. The process as described in claim 15 comprising the further step setting the parameters controlling cycling of the canard lip of the fishing lure elevator among the up and down positions and the length of time in each cycle.
